(19) United States
(12) Patent Application Publication
(10) Pub. No.: US 2011/0088004 A1
(43) Pub. Date: Apr. 14, 2011

(54) TOOL IDENTIFYING METHOD AND APPARATUS

(75) Inventor: Yuzi Kanazawa, Kawasaki (JP)

(73) Assignee: FUJITSU LIMITED, Kawasaki-shi (JP)

(21) Appl. No.: 12/899,695

(22) Filed: Oct. 7, 2010

(30) Foreign Application Priority Data
Oct. 9, 2009 (JP) 2009-235785

(51) Int. Cl. G06F 17/50

(52) U.S. Cl. 716/51

(57) ABSTRACT

A method includes generating Aₜₒₒₗ(j, i) representing an effect of a tool j for a chip i by using outputs from M kinds of tools that carries out a processing for design support for layout data of N kinds of chips; calculating a difference ε(i) between an actual parameter value of the chip i, which is stored in an actual value storage storing, for each chip, the actual parameter value, and an estimated parameter value of the chip i, which is an estimated value of the parameter value calculated from data for the chip i and stored in an estimated value storage storing, for each chip, the parameter estimate value, and calculating, for each chips i, an influence degree Xₜₒₒₗ(j) of each tool j, which satisfies ε(i)=ΣAₜₒₒₗ(j, i)*Xₜₒₒₗ(j); and identifying a tool j whose influence degree Xₜₒₒₗ(j) is largest.

### CROSS-REFERENCE TO RELATED APPLICATIONS

This application is based upon and claims the benefit of priority of the prior Japanese Patent Application No. 2009-235785, filed on Oct. 9, 2009, the entire contents of which are incorporated herein by reference.

### FIELD

This technique relates to a design support technique of a semiconductor chip.

### BACKGROUND

After certain values are assumed for parameters such as yield, consumed power and delay time to design the product, actual products are manufactured according to the design. However, when the values of the aforementioned parameters are measured for the actual products, there is a case where the assumed values cannot be realized.

In order to avoid such a situation, a following method is adopted, for example. Namely, before the manufacturing, various tools to improve the design is applied to the design data. Then, as depicted in FIG. 1, the values of the aforementioned parameters are calculated, on the model, for the design data (here, layout data) after the tool is applied and the degrees of the improvement on the values of the aforementioned parameters are compared with respect to the respective tools, and the tool to be considered as being appropriate is adopted. For example, the Simulation Program with Integrated Circuit Emphasis (SPICE) is used as the model to calculate the values of the parameters such as the consumed power and delay time. In addition, by using another model, the yield for the layout data or the like can also be calculated. Such models are typically created so as to conform to the manufacturing results as much as possible. However, because some factors are ignored due to the calculation time, it is difficult to completely conform to the manufacturing result.

There is no problem in case where an error between the model and the manufacturing result is unquestionably small. However, when the error becomes large, the aforementioned method cannot be adopted. In addition, due to the recent development of the microfabrication, the dispersion of the manufacturing result becomes large, the number of cases where the error of the model is a trouble is increasing, and the number of cases where the aforementioned method has no meaning is also increasing.

In addition, the tool that the effect can be measured on the well-known model has already been studied well, and there is also a problem that the tool has no significant effect on the differentiation with other companies.

On the other hand, a following model error analysis technique exists. Specifically, (1) for plural semiconductor chips, an estimated value T_{design} at the design and a measurement value T_{product} after the manufacturing are prepared. Then, when the error ε(N) is used for the chip N (or a circuit portion N), T_{product}(N)=T_{design}+ε(N) is satisfied. (2) In addition, the influence degrees of the factors (e.g. noise, voltage decrease, and the like) that may be causes of the error are denoted as X(1), X(2), X(3), . . . (3) The influence degree a(M, N) of the factor M for the chip N is calculated. (4) The error ε(N) is approximated by the first-order expression of the influence degree X(M) of the factor M that is a cause of the error and the influence degree a(M, N) of the factor M for the chip N. Namely, the error ε(N) is expressed as follows:

E(N)=a(1,N)*X(1)+a(2,N)*X(2)+ . . .

In such a first-order expression approximation, the change is assumed to be linear and the terms equal to or larger than the second order are ignored. Furthermore, it is assumed that the influence caused by the plural factors, interaction is also not so large, the influence is ignored.

Then, (5) X(i) satisfying the aforementioned equations is calculated by using a well-known technique such as Support Vector Machine. When the influence degree X(i) obtained by such a method is large, it can be understood that the factor is a factor whose influence is large. Therefore, (6) the tool corresponding to the factor whose influence is large is selected and applied.

However, there are a lot of cases where a processing carried out in the tool selected in (6) is different from a calculation method of the influence degree a(M, N) in (3). Therefore, there is a problem that there are a lot of cases where no effect can be obtained. Especially, in case of the yield, there are a lot of cases where the aforementioned problem occurs.

More specifically, as depicted in FIG. 2, it is considered that a signal propagation time t from a first Flip Flop (FF) (i.e. left edge FF) to a second FF (i.e. right edge FF) is analyzed. Then, as for a first path, a difference ε(1)=50 ps between the propagation time at the design and the propagation time after the manufacturing is calculated, as for a second path, ε(2)=20 ps between the propagation time at the design and the propagation time after the manufacturing is calculated, and as for a third path, ε(3)=40 ps between the propagation time at the design and the propagation time after the manufacturing is calculated.

In addition, for the factors that may be causes of the error, the error of the library, voltage decent and noise from the neighboring wires are adopted. Then, the influence degrees a(M, N) for the path N due to the respective factors M are calculated. For each path, an expression ε(N)=a(M, N)*X(M) is generated.

50 ps=0.1*X(1)+0.3*X(2)+0.05*X(3) . . . Path 1:

20 ps=0.3*X(1)+0.01*X(2)+0.15*X(3) . . . Path 2:

40 ps=0.01*X(1)+0.2*X(2)+0.1*X(3) . . . Path 3:

Those simultaneous equations are solved by the well-known technique such as the aforementioned Support Vector Machine to obtain the influence degree X(M). Then, for example, it is assumed that X(1)=50, X(2)=10, X(3)=2 . . . are obtained as results. Finally, it is understood that the factor of X(1) whose value is the largest influences the yield most. Therefore, by paying attention to the factor of X(1), the tool to modify the layout is adopted.

The above explanation was made under the assumption that the influence a(M, N) for the factor, which may be the cause of the error, can be calculated. However, a lot of works are required for the preparation of the program for this calculation.

In addition, it is assumed that the factor, which may be the cause of the error, is a non-redundant via hole. As depicted in FIG. 3A, the redundant via holes are via holes to connect a wire 1001 in the lower layer with a wire 1002 in the upper layer, which are duplicated such as via holes 1003 and 1004. Thus, even when a defect occurs in one via hole, it is possible for another one via hole to prevent from the disconnection, because of the redundancy. On the other hand, as depicted in FIG. 3B, when the via hole to connect the wire 1001 in the lower layer with the wire 1002 in the upper layer is only a via hole 1005, which is a non-redundant via hole, the possibility of the disconnection is higher than a case where the redundant via holes exits. Thus, when the layout data is analyzed, the number of non-redundant via holes can be grasped correctly, and the number of non-redundant via holes can be used for a(M, N) with no problem.

However, there are not a lot of factors whose influence degree can be correctly grasped, such as the number of non-redundant via holes. For example, it is difficult that the number of hot spots by the Optical Proximity Effect and flatness degree by the Chemical Mechanical Planarization are correctly calculated. Namely, because it is difficult to completely replicate the physical phenomena on the computer, ignored portions occur. Because the ignored portions can be freely selected, it is difficult to accord the ignored portions and/or specific calculation methods in both of the tool to modify the layout by paying attention to the factors and the calculation processing of the influence degree a(M, N) of the factors. Especially, as for the tool, there are a lot of cases where it is unknown what method or variable value is specifically adopted.

As described above, on the improvement of the values of the parameters such as the yield, consumed power and delay time, there is no conventional arts to judge which tool is appropriate among a lot of tools to improve the design.

### SUMMARY

This tool identifying method according to one aspect of this technique includes generating and storing into a storage device, a coefficient Aₜₒₒₗ(j, i) representing an effect of a tool j for a semiconductor chip i by using outputs from M kinds of tools that carries out a processing for design support for layout data of N kinds of semiconductor chips; calculating a difference ε(i) between an actual parameter value of the semiconductor chip i, which is stored in an actual parameter value storage device storing, for each of the N kinds of semiconductor chips, the actual parameter value, and an estimated parameter value of the semiconductor chip i, which is an estimated value of the parameter value calculated from data for the semiconductor chip i and stored in an estimated parameter value storage device storing, for each of the N kinds of semiconductor chip, the estimated parameter value, and calculating, for each of the semiconductor chip i, an influence degree Xₜₒₒₗ(j) of each tool j, which satisfies ε(i)=ΣAₜₒₒₗ(j, i)*Xₜₒₒₗ(j); and identifying a tool j whose influence degree Xₜₒₒₗ(j) is largest.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a diagram to explain a model;

FIG. 2 is a diagram to explain signal propagation delay;

FIG. 3A is a diagram to explain a redundant via hole, and FIG. 3B is a diagram to explain a non-redundant via hole;

FIG. 4 is a diagram to explain an OPC processing;

FIG. 5 is a diagram to explain the OPC processing;

FIG. 6 is a diagram to explain wire density of semiconductor chips;

FIG. 7 is a diagram to explain a CMP simulator;

FIG. 8 is a diagram to explain a dummy metal insertion pattern;

FIG. 9 is a diagram to explain a critical area;

FIG. 10 is a diagram to explain a critical area;

FIG. 11 is a diagram to explain a critical area;

FIG. 12 is a functional block diagram of an embodiment of this technique;

FIG. 13 is a diagram depicting a processing flow of the embodiment;

FIG. 14A to 14C are diagrams depicting calculation examples of coefficients Aₜₒₒₗ;

FIG. 15 is a diagram depicting an example of calculation of the error ε(N);

FIG. 16 is a diagram depicting a processing of the embodiments;

FIG. 17 is a functional block diagram of a computer; and

FIG. 18 is a functional block diagram of a tool identifying apparatus.

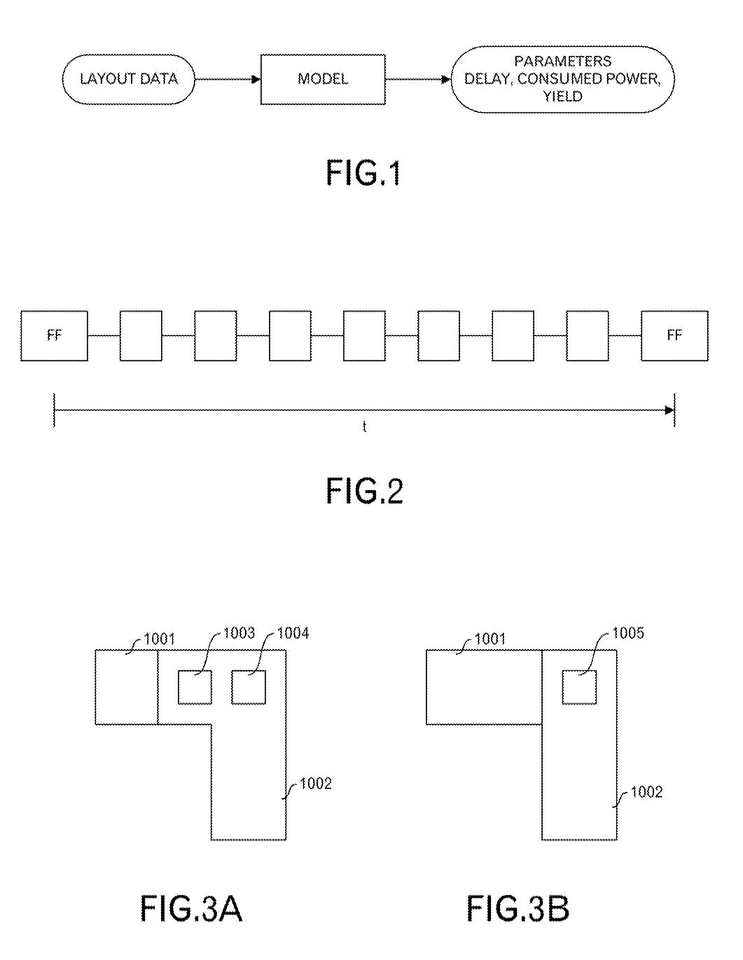

### DESCRIPTION OF EMBODIMENTS

In this embodiment, an expression format ε(N)=Σa(M, N)*X(M) and a point that the largest X(M) is identified among all calculated X(M), which are solutions of the expression, are adopted.

Namely, ε(N) represents an error of the semiconductor chip N between an actual measurement value of a certain parameter and an estimated value (also called a “model value”) of the certain parameter, which is calculated according to a predetermined model. On the other hand, in this embodiment, the influence degree for the factor, which may be the cause of the error, is not used, but the influence degree of the tool is directly estimated. Namely, numerical values representing the effect of the tool are used as Xₜₒₒₗ(1), Xₜₒₒₗ(2), . . . . In addition, a coefficient representing the effect of the tool M for the semiconductor chip N is represented by Aₜₒₒₗ(M, N). Then, Aₜₒₒₗ(M, N) is calculated by using the output of the tool M. For example, the area of a difference between the layout data before inputting to the tool and the layout data outputted from the tool is calculated and used as Aₜₒₒₗ(M, N).

Then, as for plural semiconductor chips N, Xₜₒₒₗ(M) satisfying ξ(N)=ΣAₜₒₒₗ(M, N)*Xₜₒₒₗ(M) is calculated, and a tool whose Xₜₒₒₗ(M) is maximum is identified as an effective tool, which influences the semiconductor chip to be improved largely.

Because the solutions of the aforementioned expressions are calculated by using the outputs of the tools, it becomes possible to avoid the problem caused by the inconsistency between the tool and the calculation method of a(M, N).

In the following, some technical points are previously explained.

A. Tool for Improving the Design

1. Layout Modification Tool for Hot Spots

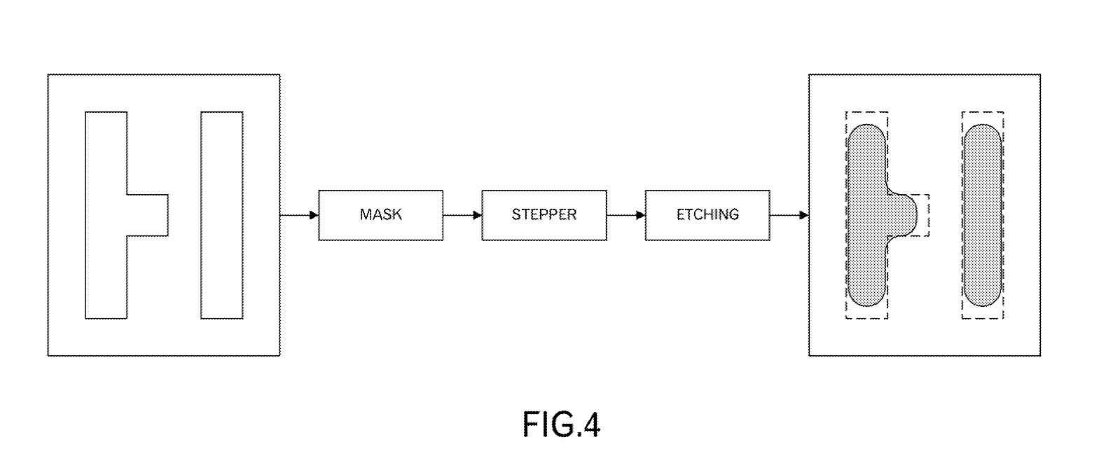

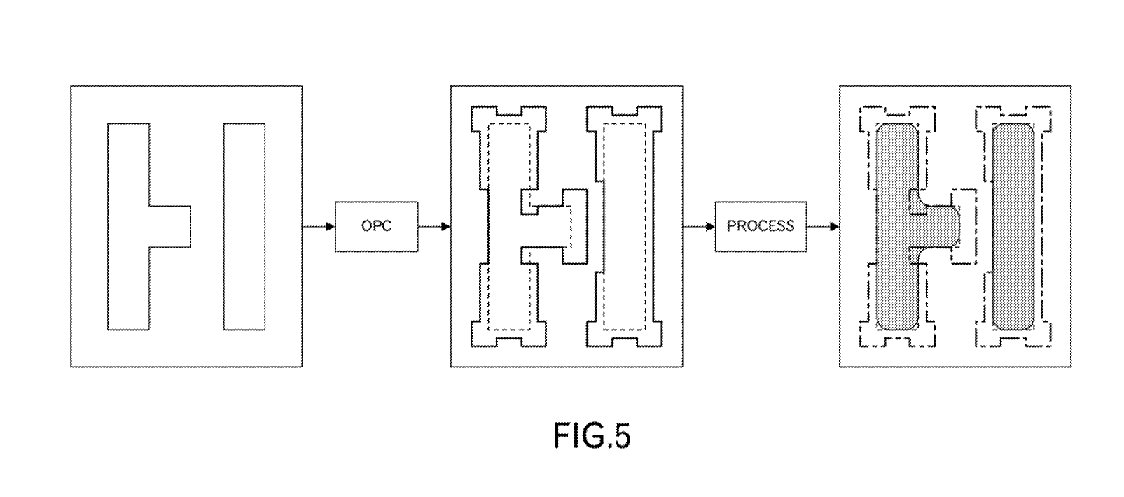

In a range shorter than a wavelength of a light used for the exposure, the mask pattern is exposed deformationally due to the OPE. The Optical Proximity Correction (OPC) processing is a processing to generate the mask while predicting the deformation in advance. For example, in case where a shape as depicted in the left of FIG. 4 is formed on the semiconductor chip, when the mask is created without the OPC processing, the exposure is carried out by the stepper and the etching is further carried out, a deformed shape with hatching is formed as schematically depicted in the right of FIG. 4. On the other hand, in case where the same shape as that in FIG. 4 is formed as depicted in the left of FIG. 5, when the OPC processing is carried out, a shape is deformed as depicted in the center of FIG. 5 by the thick line. The dotted lines in the center of FIG. 5 represent the shape in the left of FIG. 5. Then, when the mask is created, the exposure is carried out by the stepper and the etching is carried out (i.e. process is carried out), a shape of the hatched portions is formed as depicted in the right of FIG. 5. The shape of the hatched portions in the right of FIG. 5 is almost the same as the shape depicted in the left of FIG. 5.

When the yield improvement only by the OPC processing is insufficient, an additional processing is carried out in order to further improve the yield. For example, according to the layout, hot spots (i.e. pattern fault points) that the OPC processing cannot easily solve appear. The hot spots are determined based on the interrelation between the neighboring shapes. However, a lot of works is required for the extraction of the hot spots and the layout modification for the extracted hot spots. However, a tool to extract the hot spots and modify the layout based on the extracted hot spots has already been provided. Such a tool to extract the hot spots and modify the layout based on the extracted hot spots is one of choices when a parameter such as the yield is selected for the improvement.

2. Processing Tool for Flatness Degree of Semiconductor Chip

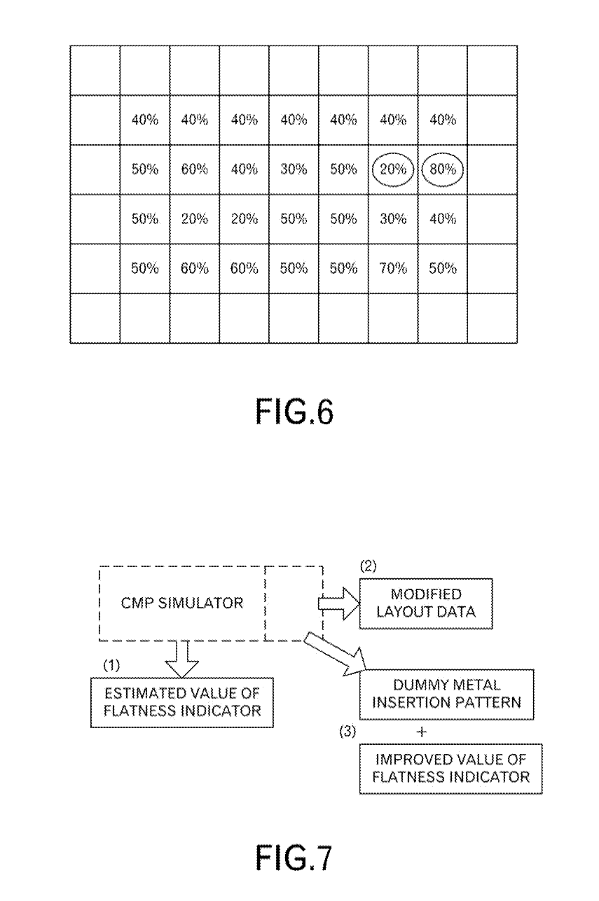

In case where the multi-layer wiring is adopted, the yield is deteriorated when the surface of the semiconductor ship is not flat. This is because the defective wiring is easily caused by the inflatness of the surface of the semiconductor chip. Then, typically, the surface of the semiconductor chip is made flat by the CMP. As depicted in FIG. 6, a CMP simulator divides the semiconductor chip into a mesh based on the layout data of the semiconductor chip and calculates distribution of the wiring density for each element in the mesh. Basically, portions whose wiring density is rapidly changed influence the yield. For example, portions that the numerical value of the wiring density is surrounded by a circle in FIG. 6 become problems, because a mesh element whose wiring density is 20% is adjacent to another mesh element whose wiring density is 80%.

The CMP simulator is assumed to output various outputs. For example, as depicted in FIG. 7, there are cases where (1) an estimated value of the flatness indicator is outputted, (2) a layout data modified by a processing to improve the flatness is outputted, and (3) a dummy metal insertion pattern representing how to insert the dummy metal used to improve the flatness and an improved value of the flatness indicator in case where the dummy metal insertion pattern is adopted are outputted. In case (1), based on this output, the user carries out any measure to improve the flatness. In case (2), the outputted layout data can be used as it is. In case (3), it is possible for the user to judge whether or not the dummy metal insertion pattern should be used, after grasping the improvement degree of the flatness indicator.

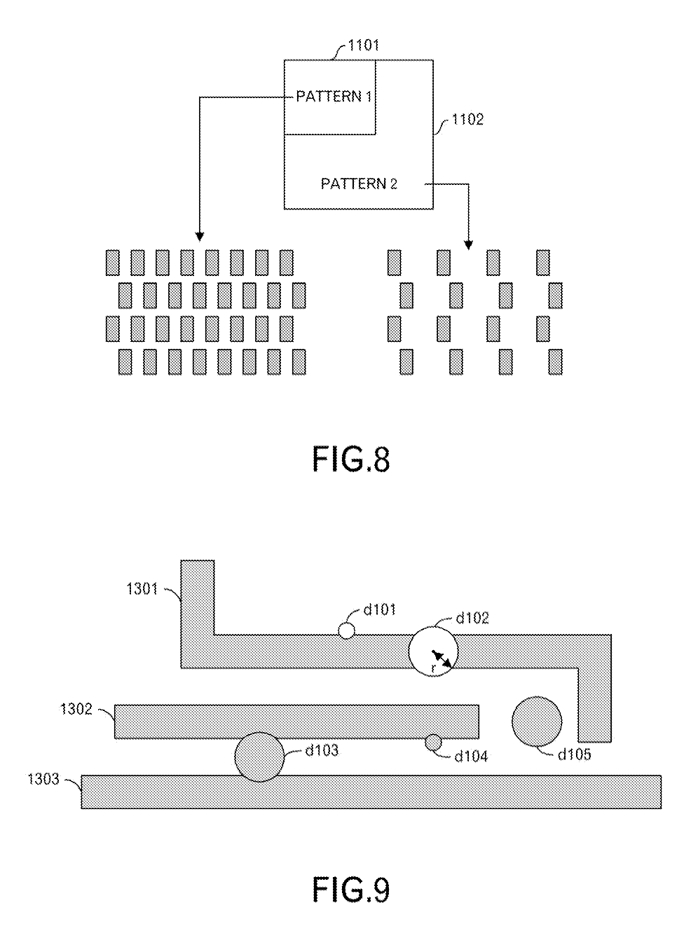

Incidentally, the dummy metal is inserted in order to uniformalize the wiring density, when the wiring density widely varies, and the flatness is improved by inserting the dummy metal. For example, when a portion whose wiring density is low exists, a dummy metal insertion pattern in which the dummy metal is inserted into such a portion is determined. As for the dummy metal, an insertion pattern to insert the metal with high density, an insertion pattern to insert the metal with relatively low density, a long strip pattern to insert the metal between wires and the like are prepared and any one of the patterns is selected, for example, for each area in the semiconductor chip. For example, as depicted in FIG. 8, a pattern 1 to insert the metal with high density is used for an area 1101 of the semiconductor chip, because the wiring density is low, and a pattern 2 to insert the metal with low density is used for an area 1102, because the wiring density is relatively high. In (3) of FIG. 7, data as depicted in FIG. 8 is outputted, as a dummy metal insertion pattern, with an improved value of the flatness indicator. Incidentally, the modified layout data after applying the dummy metal insertion pattern as depicted in FIG. 8 to the inputted layout data may be generated.

Incidentally, in the CMP simulator, the size of the mesh elements, the position of the origin, the threshold used to judge whether or not the wiring density is high and the like are arbitrary. Therefore, even when those values are presumed and a(M, N) is calculated based on the presumption, the consistent result may not be obtained.

3. Others

A tool to count and output, as an estimated value, the number of non-redundant via holes, change the non-redundant via hole to the redundant via hole if possible and output the number of changes as the improved value may be used. Furthermore, the changed layout data may be outputted.

Furthermore, various tools can be adopted for the candidates.

B. Model

1. Yield

ε(N) is a difference, in the semiconductor chip N, between the actual value of the parameter to be considered and the estimated value calculated according to a predetermined model. Therefore, the estimated value of the parameter to be considered is calculated according to the predetermined model. When the parameter to be considered is the yield. The yield is calculated by the following processing.

Specifically, a critical area CA is calculated from the layout data, and (1−g*CA) is calculated as the yield by using a predetermined coefficient g.

For example, in FIG. 9, defects d101 to d105 occur in wires 1301 to 1303, the wire 1301 is broken by the defect d102, and the wires 1302 and 1303 are shorted by the defect d103. On the other hand, the defect d105 does not overlap with the wires 1301 to 1303. Therefore, the defect d105 is not a defect causing the failure.

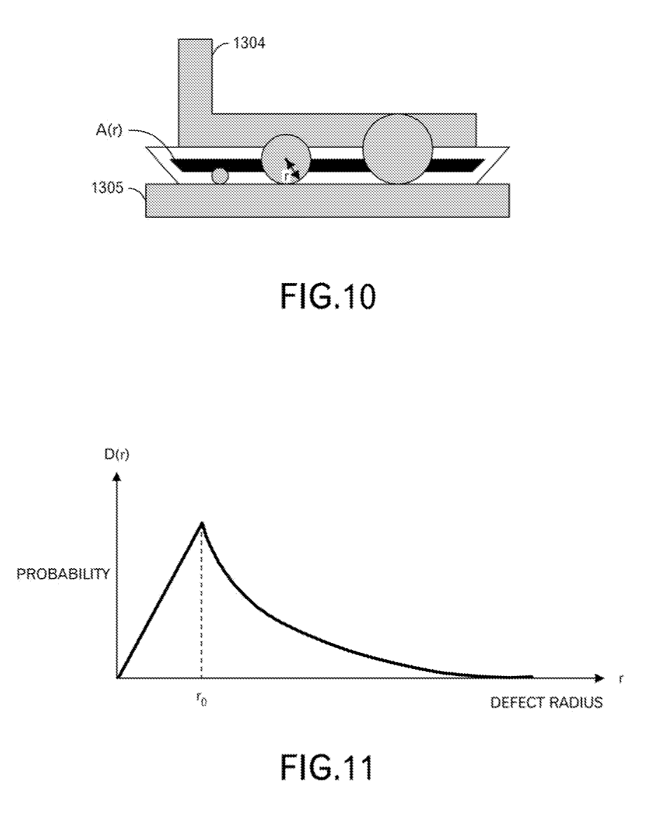

The critical area is an indicator representing the occurrence probability of the failure, and as depicted in FIG. 10, when an area of a region between, for example, the wires 1304 and 1305, in which a center of the defect causing the failure is disposed, is denoted as a “failure region area A(r)”, and the radius of the defect is denoted as “r”, the occurrence probability D(r) of the defect is represented as follows:

$$CA = {\int }_{0}^{∞} A ( r ) D ( r ) d r$$

An example of the relation between the radius r of the defect and the occurrence probability D(r) of the defect is depicted in FIG. 11. In an example of FIG. 11, the occurrence probability increases until the radius r0. However, when the radius r increases more, the occurrence probability decreases.

The calculation method of the critical area is disclosed in the following paper, Matsuoka Hidetoshi, Honma Katsumi, Ohtsuka Ikuo and Shibuya Toshiyuki, “A Critical Area Reducing Re-routing Method for Yield Improving”, IEICE Technical Report, Vol. 104, No. 115, CAS2004-19, pp. 55-60, Jun. 11, 2004, and Japanese Patent No. 4071537 (published as Japanese Laid-open Patent Publication No. 2003-332427). Therefore, further explanation is omitted.

2. Consumed Power and Delay Time

For example, by using, as the model, SPICE, it is possible to calculate the consumed power from the output from the power meter or the like, which is provided in the circuit, for example. In addition, by using, as the model, SPICE, it is possible to calculate the delay time from the signal waves of the circuits to be considered or the like.

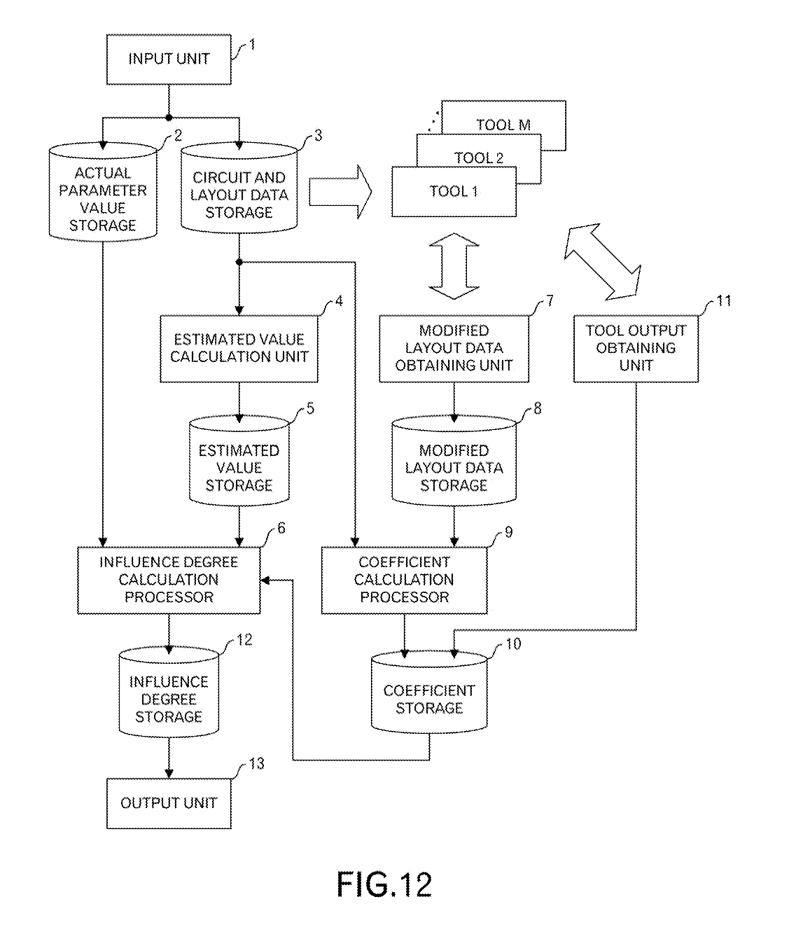

Next, FIG. 12 depicts a functional block diagram of a tool identifying apparatus relating to this embodiment. The tool identifying apparatus depicted in FIG. 12 includes (A) an input unit 1; (B) an actual parameter value storage 2 storing actual parameter values inputted through the input unit 1; (C) a circuit and layout data storage 3 storing circuit data and layout data of the semiconductor chips to be processed, which are inputted through the input unit 1; (D) an estimated value calculation unit 4 to calculate estimated parameter values by using data stored in the circuit and layout data storage 3; (E) an estimated value storage 5 storing the estimated parameter values calculated by the estimated value calculation unit 4; (F) a modified layout data obtaining unit 7 to obtain modified layout data from tools to be considered; (G) a modified layout data storage 8 storing the modified layout data obtained by the modified layout data obtaining unit 7; (H) a coefficient calculation processor 9 to calculate a coefficient Aₜₒₒₗ(M, N) by calculating a difference area in the layout data by using data stored in the circuit and layout data storage 3 and the modified layout data storage 8; (I) a tool output obtaining unit 11 to obtain estimated value or improved values from the tools to be considered; (J) a coefficient storage 10 storing outputs from the coefficient calculation processor 9 and/or the tool output obtaining unit 11; (K) an influence degree calculation processor 6 to calculate an influence degree of the tools to be considered by using data stored in the actual parameter value storage 2, the estimated value storage 5 and the coefficient storage 10; (L) an influence degree storage 12 storing outputs of the influence degree calculation processor 6; and (M) an output unit 13 to output identification data of the most appropriate tool by using data stored in the influence degree storage 12.

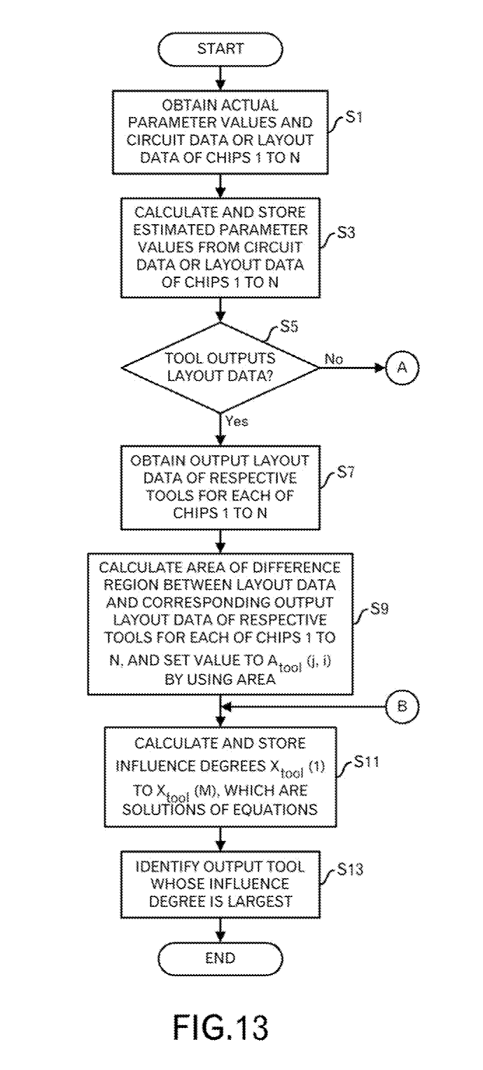

Next, processing contents of the tool identifying apparatus will be explained by using FIGS. 13 to 16. First, a designer measures actual parameter values (e.g. actual yield, actual delay time, actual consumed power and the like) of the semiconductor chips 1 to N, and inputs the values into the input unit 1 of the tool identifying apparatus. In addition, the designer also inputs the circuit data or layout data of the semiconductor chips 1 to N into the input unit 1. The designer may instructs the input unit 1 to obtain files including the circuit data or layout data by designating the file name or the like.

The input unit 1 obtains the actual parameter values of the semiconductor chips 1 to N and stores them into the actual parameter value storage 2, and obtains the circuit data or layout data of the semiconductor chips 1 to N and stores it into the circuit and layout data storage 3 (step S1). Next, the estimated value calculation unit 4 calculates the estimated parameter values of the semiconductor chips 1 to N from the layout data or circuit data of the semiconductor chips 1 to N, which is stored in the circuit and layout data storage 3, and stores the calculated values into the estimated value storage 5 (step S3). When the actual yield is improved, the estimated value of the yield is calculated by a well-known method from the layout data, for example. When the delay time or consumed power is improved, the estimated value is calculated by a well-known method from the circuit data, for example.

Then, when the tools 1 to M to be considered output the layout data (step S5: Yes route), processing at the step S7 and subsequent steps is carried out. On the other hand, when the tools 1 to M to be considered output the estimated values or improved values (step S5: No route), a processing after a terminal A is carried out.

Incidentally, the tools 1 to M may generate modified layout data by using the layout data of the respective semiconductor chips, which is stored in the circuit and layout data storage 3, and may output the modified layout data. In addition, the tools 1 to M may calculate and output the estimated values or the improved values of the parameters.

Firstly, a case where the tools 1 to M to be considered output the layout data will be explained. The modified layout data obtaining unit 7 obtains, for each of the semiconductor chips 1 to N, outputted modified layout data from the respective tools, and stores the modified layout data into the modified layout data storage 8 (step S7). Because the number of tools is M and the number of semiconductor chips is N, M*N kinds of layout data are obtained.

Then, the coefficient calculation processor 9 calculates an area of a difference region between the layout data of the semiconductor chip i and the corresponding modified layout data of the tool j for each combination of i and j, and stores, as a coefficient Aₜₒₒₗ(j, i), the calculated values into the coefficient storage 10 (step S9). The difference region between the layout data before the modification and the modified layout data by the tool j is extracted for the same semiconductor chip i, and the area of the difference region is calculated to set a value to the coefficient Aₜₒₒₗ(j, i) by using the area of the difference region. Incidentally, depending on the tools to be considered, the calculated areas may vary widely. In such a case, the finally calculated Xₜₒₒₗ(M) is influenced by this dispersion. Therefore, because N semiconductor chips are used for one tool, the value range is normalized into a range [0, 1], for example, by using, for example, these variance.

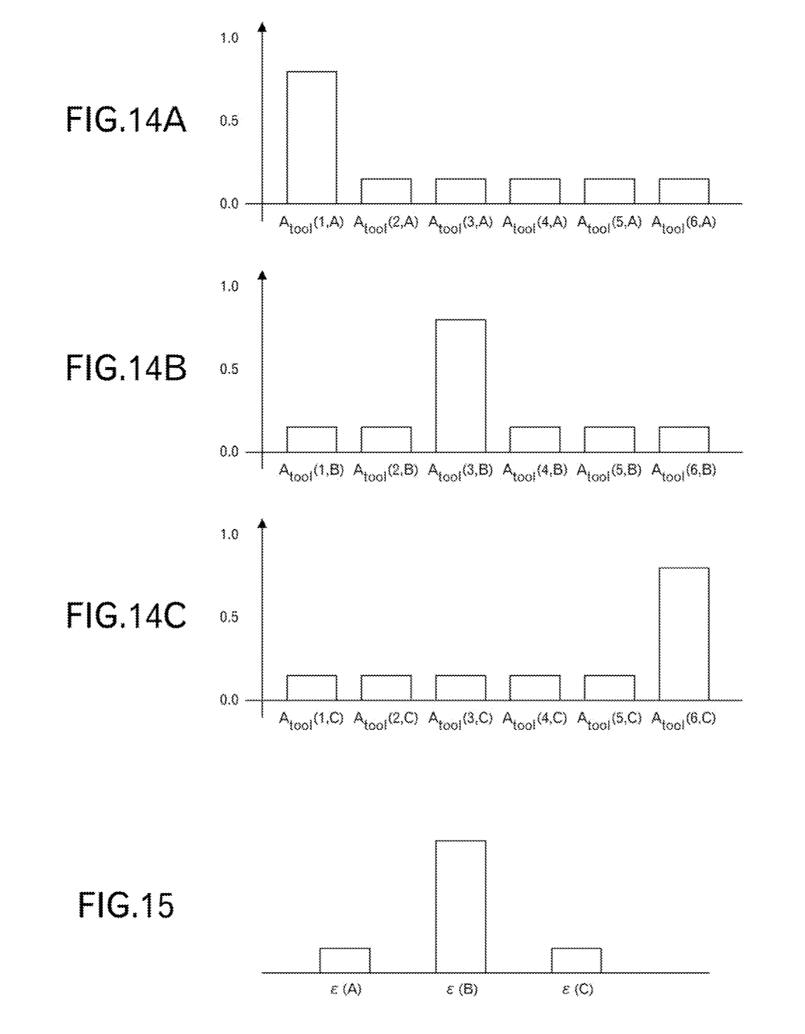

FIG. 14A depicts Aₜₒₒₗ(1, A) to Aₜₒₒₗ(6, A) calculated when the tools 1 to 6 are applied to the semiconductor chip A. In the example of FIG. 14A, as for the semiconductor chip A, it is understood that the influence of the tool 1 is large. Similarly, FIG. 14B depicts Aₜₒₒₗ(1, B) to Aₜₒₒₗ(6, B) calculated when the tools 1 to 6 are applied to the semiconductor chip B. In the example of FIG. 14B, as for the semiconductor chip B, it is understood that the influence of the tool 3 is large. Similarly, FIG. 14C depicts Aₜₒₒₗ(1, C) to Aₜₒₒₗ(6, C) calculated when the tools 1 to 6 are applied to the semiconductor chip C. In the example of FIG. 14C, as for the semiconductor chip C, it is understood that the influence of the tool 6 is large.

The influence degree calculation processor 6 calculates differences ε(1) to ε(N) between the actual parameter values of the semiconductor chips 1 to N, which are stored in the actual parameter value storage 2, and the estimated parameter values stored in the estimated value storage 5, calculates, for all combinations of the semiconductor chips 1 to N and the tools 1 to M, the influence degrees Xₜₒₒₗ(1) to Xₜₒₒₗ(M), which satisfy an expression ε(i)=ΣAₜₒₒₗ(j, i)*Xₜₒₒₗ(j), and stores the influence degrees into the influence degree storage 12 (step S11). As described above, a well-known technique such as Support Vector Machine or the like is used for this processing.

For example, as depicted in FIG. 15, when ε(B) is relatively greater than ε(A) and ε(C), the influence degree of the tool whose coefficient Aₜₒₒₗ is large for the semiconductor chip B also becomes large. Therefore, in the example of FIG. 14B, Xₜₒₒₗ(3) becomes large.

Then, the output unit 13 compares the influence degrees Xₜₒₒₗ(j) of the respective tools, which are stored in the influence degree storage 12, identifies, as the most effective tool, a tool whose influence degree is the largest, and outputs data regarding the identified tool, to an output device such as a display apparatus, printer or the like, or to another apparatus connected through a network (step S13). In the aforementioned example, the tool “3” whose influence degree Xₜₒₒₗ(3) is the largest is selected and identification information of the tool “3” is outputted.

By carrying out the aforementioned processing, it becomes possible to identify the most effective tool by using the already manufactured semiconductor chips without any trial manufacture. In addition, the factors of the error in the model are not identified, but the effective tool is identified after totally considering the factors. Incidentally, because the processing is carried out based on the output of the tool, any problem that unintentional result is obtained does not occur.

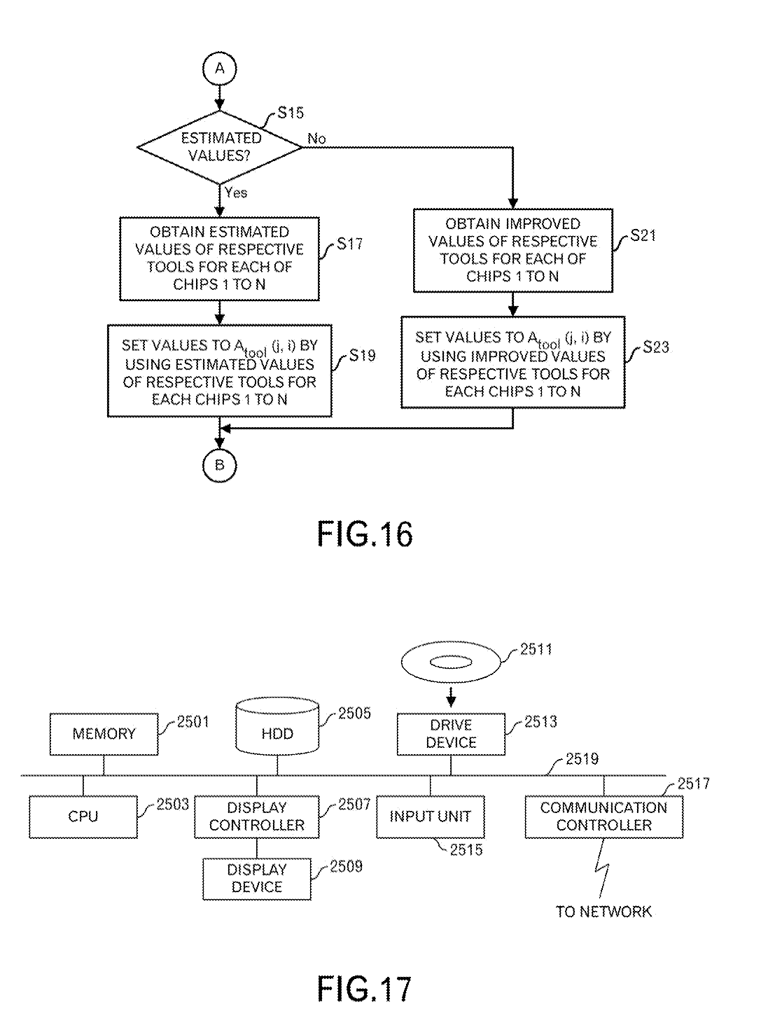

Next, the processing after the terminal A will be explained by using FIG. 16.

Incidentally, in this portion of the processing, the tools 1 to M calculate estimated values or improved values such as predetermined physical amount or the like by using the layout data of the respective layout data or the circuit data, which is stored in the circuit and layout data storage 3, and outputs the estimated values or improved values.

When the tools 1 to M outputs the estimated values (step S15: Yes route), the output obtaining unit 11 obtains the estimated values of the respective tools for each of the semiconductor chips 1 to N (step S17), calculates the coefficient Aₜₒₒₗ(j, i) by using the obtained estimated values, for each combination of the semiconductor chip i and the tool j, and stores the coefficients into the coefficient storage 10 (step S19). The estimated values are also normalized. However, the estimated values may be used for the coefficient Aₜₒₒₗ as they are. Then, the processing returns to the step S11 through a terminal B.

On the other hand, when the tools 1 to M does not output the estimated values (step S15: No route), the tool output obtaining unit 11 obtains the improved values of the respective tools for each of the semiconductor chips 1 to N (step S21), calculates the coefficient Aₜₒₒₗ(j, i) by using the improved values for each combination of the semiconductor chip i and the tool j, and stores the coefficients into the coefficient storage 10 (step S23). The improved values are also normalized. However, the improved values may be used for Aₜₒₒₗ as they are. Then, the processing returns to the step S11 through the terminal B.

Incidentally, the improved values or estimated values may be further processed.

By carrying out the aforementioned processing, it becomes possible to handle the tools to output the estimated values or improved values, not the layout data.

By carrying out the aforementioned processing, it becomes possible to identify the effective tool statistically for the semiconductor chips to be considered.

Although the embodiments of this technique were explained, this technique is not limited to those. For example, the functional block configuration of the tool identifying apparatus depicted in FIG. 12 is a mere example, and does not always correspond to the actual program configuration. In addition, the tools 1 to M may be implemented in apparatuses different from the tool identifying apparatus or may be implemented in the same apparatus. Furthermore, some functions in the tool identifying apparatus may be implemented in different apparatuses to cooperate each other and derive the processing results.

Furthermore, in the aforementioned example, the output from the all tools to be considered is any one of the layout data, estimated value and improved value. However, the tools whose type of the output data is different may be used together.

In addition, the tool identifying apparatus is a computer device as shown in FIG. 17. That is, a memory 2501 (storage device), a CPU 2503 (processor), a hard disk drive (HDD) 2505, a display controller 2507 connected to a display device 2509, a drive device 2513 for a removable disk 2511, an input device 2515, and a communication controller 2517 for connection with a network are connected through a bus 2519 as shown in FIG. 17. An operating system (OS) and an application program for carrying out the foregoing processing in the embodiment, are stored in the HDD 2505, and when executed by the CPU 2503, they are read out from the HDD 2505 to the memory 2501. As the need arises, the CPU 2503 controls the display controller 2507, the communication controller 2517, and the drive device 2513, and causes them to perform necessary operations. Besides, intermediate processing data is stored in the memory 2501, and if necessary, it is stored in the HDD 2505. In this embodiment of this invention, the application program to realize the aforementioned functions is stored in the removable disk 2511 and distributed, and then it is installed into the HDD 2505 from the drive device 2513. It may be installed into the HDD 2505 via the network such as the Internet and the communication controller 2517. In the computer as stated above, the hardware such as the CPU 2503 and the memory 2501, the OS and the necessary application programs systematically cooperate with each other, so that various functions as described above in details are realized.

The aforementioned embodiments are outlined as follows:

A tool identifying method relating to the embodiments includes generating and storing into a storage device, a coefficient Aₜₒₒₗ(j, i) representing an effect of a tool j for a semiconductor chip i by using outputs from M kinds of tools that carries out a processing for design support for layout data of N kinds of semiconductor chips; calculating a difference ε(i) between an actual parameter value of the semiconductor chip i, which is stored in an actual parameter value storage device storing, for each of the N kinds of semiconductor chips, the actual parameter value, and an estimated parameter value of the semiconductor chip i, which is an estimated value of the parameter value calculated from data for the semiconductor chip i and stored in an estimated parameter value storage device storing, for each of the N kinds of semiconductor chip, the estimated parameter value, and calculating, for each of the semiconductor chip i, an influence degree Xₜₒₒₗ(j) of each tool j, which satisfies ε(i)=ΣAₜₒₒₗ(j, i)*Xₜₒₒₗ(j); and identifying a tool j whose influence degree Xₜₒₒₗ(j) is largest.

Because the influence degrees of the tools for the parameter values such as the yield can be calculated with high accuracy by directly processing the outputs of the tools, it becomes possible to adopt the most effective tool.

Outputs from the aforementioned tools may be layout data after the modification (also called “modified layout data”). In this case, the aforementioned generating may include calculating a coefficient Aₜₒₒₗ(j, i) by using a difference area between the layout data of the semiconductor chip i, which is stored in a layout data storage device storing the layout data of N kinds of semiconductor chips, and the layout data after the modification from the tool j for the semiconductor chip i.

In these embodiments, it is assumed that, when the layout change is large, the tool provides large influence to the chip to be improved. Therefore, it is expected that the parameter value such as the chip yield is improved, when the tool providing large influence is selected.

In addition, the output from the aforementioned tool may include the estimated value or improved value of a predetermined physical amount for the semiconductor chip. Not only the layout change, but also the estimated value of the flatness or improved value of the flatness of the semiconductor chip may be used, for example.

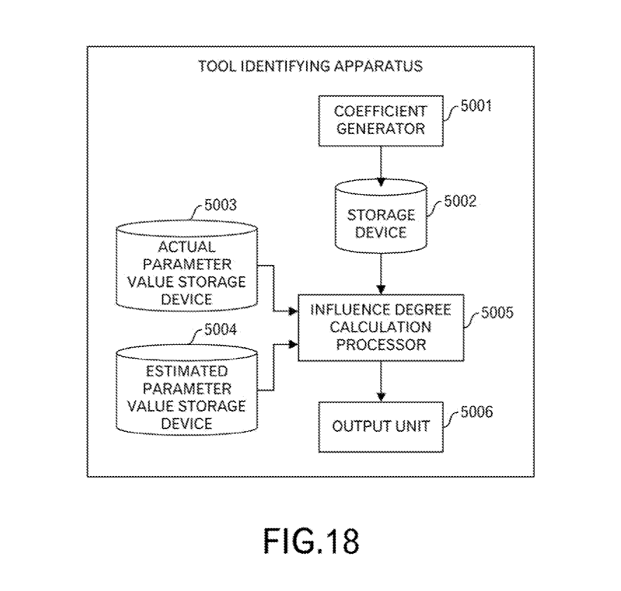

Furthermore, this tool identifying apparatus (FIG. 18) includes a coefficient generator to generate and store into a storage device (5002 in FIG. 18), a coefficient Aₜₒₒₗ(j, i) representing an effect of a tool j for a semiconductor chip i by using outputs from M kinds of tools that carries out a processing for design support for layout data of N kinds of semiconductor chips; an influence degree calculation processor (5005 in FIG. 18) to calculate a difference ε(i) between an actual parameter value of the semiconductor chip i, which is stored in an actual parameter value storage device (5003 in FIG. 18) storing, for each of the N kinds of semiconductor chips, the actual parameter value, and an estimated parameter value of the semiconductor chip i, which is an estimated value of the parameter value calculated from data for the semiconductor chip i and stored in an estimated parameter value storage device (5004 in FIG. 18) storing, for each of the N kinds of semiconductor chip, the estimated parameter value, and to calculate, for each of the semiconductor chip i, an influence degree Xₜₒₒₗ(j) of each tool j, which satisfies ε(i)=ΣAₜₒₒₗ(j, i)*Xₜₒₒₗ(j); and an output unit (5006 in FIG. 18) to identify a tool j whose influence degree Xₜₒₒₗ(j) is largest.

Incidentally, it is possible to create a program causing a computer to execute the aforementioned processing, and such a program is stored in a non-transitory computer readable storage medium or storage device such as a flexible disk, CD-ROM, DVD-ROM, magneto-optic disk, a semiconductor memory, and hard disk. In addition, the intermediate processing result is temporarily stored in a storage device such as a main memory or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A non-transitory computer-readable storage medium storing a tool identifying program to execute a process, said process comprising:
generating a coefficient Aₜₒₒₗ(j, i) representing an effect of a tool j for a semiconductor chip i by using outputs from M kinds of tools that carries out a processing for design support for layout data of N kinds of semiconductor chips;
calculating a difference ε(i) between an actual parameter value of said semiconductor chip i, which is stored in an actual parameter value storage device storing, for each of said N kinds of semiconductor chips, said actual parameter value, and an estimated parameter value of said semiconductor chip i, which is an estimated value of said parameter value calculated from data for said semiconductor chip i and stored in an estimated parameter value storage device storing, for each of said N kinds of semiconductor chips, said estimated parameter value;
calculating, for each of said semiconductor chips i, an influence degree Xₜₒₒₗ(i) of each tool j, which satisfies ε(i)=ΣAₜₒₒₗ(j, i)*Xₜₒₒₗ(j); and
identifying a tool j whose influence degree Xₜₒₒₗ(i) is largest.

2. The non-transitory computer-readable storage medium as set forth in claim 1, wherein said outputs from said M kinds of tools are modified layout data, and
said generating comprises:
calculating said coefficient Aₜₒₒₗ(j, i) by using a difference area between layout data of said semiconductor chip i, which is stored in a layout data storage device storing said layout data of said N kinds of semiconductor chips, and said modified layout data from said tool j for said semiconductor chip i.

3. The non-transitory computer-readable storage medium as set forth in claim 1, wherein said outputs from said M kinds of tools are estimated values or improved values of a predetermined physical amount for said semiconductor chips.

4. A tool identifying method, comprising:
generating a coefficient Aₜₒₒₗ(j, i) representing an effect of a tool j for a semiconductor chip i by using outputs from M kinds of tools that carries out a processing for design support for layout data of N kinds of semiconductor chips;
calculating a difference ε(i) between an actual parameter value of said semiconductor chip i, which is stored in an actual parameter value storage device storing, for each of said N kinds of semiconductor chips, said actual parameter value, and an estimated parameter value of said semiconductor chip i, which is an estimated value of said parameter value calculated from data for said semiconductor chip i and stored in an estimated parameter value storage device storing, for each of said N kinds of semiconductor chips, said estimated parameter value;
calculating, for each of said semiconductor chips i, an influence degree Xₜₒₒₗ(j) of each tool j, which satisfies ε(i)=ΣAₜₒₒₗ(j, i)*Xₜₒₒₗ(j); and
identifying a tool j whose influence degree Xₜₒₒₗ(j) is largest.

5. A tool identifying apparatus, comprising:
a storage device;
a coefficient generator to generate a coefficient Aₜₒₒₗ(j, i) representing an effect of a tool j for a semiconductor chip i by using outputs from M kinds of tools that carries out a processing for design support for layout data of N kinds of semiconductor chips, and to store said coefficient Aₜₒₒₗ(j, i) into said storage device;
an influence degree calculation unit to calculate a difference ε(i) between an actual parameter value of said semiconductor chip i, which is stored in an actual parameter value storage device storing, for each of said N kinds of semiconductor chips, said actual parameter value, and an estimated parameter value of said semiconductor chip i, which is an estimated value of said parameter value calculated from data for said semiconductor chip i and stored in an estimated parameter value storage device storing, for each of said N kinds of semiconductor chips, said estimated parameter value, and to calculate, for each of said semiconductor chips i, an influence degree Xₜₒₒₗ(j) of each tool j, which satisfies ε(i)=ΣAₜₒₒₗ(j, i)*Xₜₒₒₗ(j); and
an output unit to identify a tool j whose influence degree Xₜₒₒₗ(j) is largest.

6. A tool identifying apparatus, comprising:
a memory configured to store, for each of N kinds of semiconductor chips, an actual parameter value and an estimated parameter value, which is an estimated value of a parameter value; and
a processor configured to execute a procedure, the procedure comprising:
generating a coefficient Aₜₒₒₗ(j, i) representing an effect of a tool j for a semiconductor chip i by using outputs from M kinds of tools that carries out a processing for design support for layout data of said N kinds of semiconductor chips, and to store said coefficient Aₜₒₒₗ(j, i) into said memory;
calculating a difference ε(i) between an actual parameter value of said semiconductor chip i, which is stored in said memory, and an estimated parameter value of said semiconductor chip i, which is stored in said memory, and to calculate, for each of said semiconductor chips i, an influence degree Xₜₒₒₗ(j) of each tool j, which satisfies ε(i)=ΣAₜₒₒₗ(j, i)*Xₜₒₒₗ(j); and
identifying a tool j whose influence degree Xₜₒₒₗ(j) is largest.
